(19) United States
(12) Patent Application Publication
(10) Pub. No.: US 2012/0321380 A1
(43) Pub. Date: Dec. 20, 2012

(54) RETENTION MEMBER

(75) Inventor: Masaki Enomoto, Tokyo (JP)

(73) Assignee: SONY CORPORATION, Tokyo (JP)

(21) Appl. No.: 13/489,898

(22) Filed: Jun. 6, 2012

(30) Foreign Application Priority Data
Jun. 14, 2011 (JP) 2011-132132

(51) Int. Cl. F16B 12/00

(52) U.S. Cl. 403/376

(57) ABSTRACT

A retention member is formed from an elastically deformable material for being inserted into a fitting hole formed in an attachment body to which an attachment object body having an insertion projection is to be attached or in an attachment object body to be attached to such attachment body having an insertion projection. The retention member has an outer cylinder portion for being fitted into the fitting hole, an inner cylinder portion positioned in a spaced relationship from an inner circumferential face of the outer cylinder portion in the outer cylinder portion for receiving the insertion projection inserted therein, and a plurality of connecting portions connected at the opposite ends thereof to the inner circumferential face of the outer cylinder portion and an outer circumferential face of the inner cylinder portion and positioned in a spaced relationship from each other in a circumferential direction of the inner cylinder portion.

### BACKGROUND

The present technology relates to a retention member, and particularly to a retention member in which an insertion projection is inserted into a fitting hole to attach an attachment object body to an attachment body.

A structure is available in which a plurality of insertion projections or fitting holes formed on or in an attachment object body and a plurality of fitting holes or insertion projections formed in or on an attachment body are fitted with each other to attach the attachment object body to the attachment body.

Such a structure in which a plurality of insertion projections and a plurality of fitting holes are fitted with each other to attach an attachment object body to an attachment body as described above is provided on an electronic apparatus rack for accommodating or receiving various kinds of electronic apparatus such as, for example, a television receiver, a recording and reproduction apparatus such as a disk recorder, an image pickup apparatus such as a video camera or a still camera, and an information processing apparatus such as a personal computer therein or thereon.

Further, the structure in which the attachment object body is attached to the attachment body is provided also on various kinds of electronic apparatus such as, for example, a speaker apparatus.

For example, as a speaker apparatus, an apparatus is available in which a speaker grill, which is an attachment object body, for carrying out protection and so forth of a speaker unit is attached to a speaker box, which is an attachment body, having the speaker unit. A speaker apparatus of the type just described is disclosed, for example, in Japanese Patent Laid-Open No. 2008-124968 (hereafter, referred to as Patent Document 1).

In the speaker apparatus disclosed in Patent Document 1, a plurality of insertion projections or projecting portions provided on a speaker box are inserted into and fitted with a plurality of fitting holes or through-holes formed in a speaker grill to attach the speaker grill to the speaker box.

### SUMMARY

Incidentally, in the structure in which the plural insertion projections and the plural fitting holes are fitted with each other to attach the attachment object body to the attachment body, there is the possibility that, if the distances between (the pitch of) the plural fitting holes and the distances between (the pitch of) the plural insertion projections corresponding to the fitting holes are different from each other arising from processing accuracy, then positional displacement of the insertion projections with respect to the fitting holes may occur.

Also where the distances between (the pitch of) the plural fitting holes and the distances between (the pitch of) the plural insertion projections corresponding to the fitting holes are formed equal to each other, there is the possibility that contraction or expansion may occur with the attachment object body or the attachment body arising from an external environment such as a temperature after attachment of the attachment object body to the attachment body to cause positional displacement of the insertion projections with respect to the fitting holes.

If such positional displacement of the insertion projections with respect to the fitting holes occurs, then unnecessary force is applied to the fitting portions in a state in which the attachment object body is attached to the attachment body. Therefore, there is the possibility that deformation such as warping may occur with the attachment object body or the attachment body or the attachment object body may float with respect to the attachment body to make the attachment state of the attachment object body to the attachment body unstable.

Also the speaker apparatus disclosed in Patent Document 1 has, similarly to the technology described above, a structure in which the insertion projection is fitted into the fitting hole to attach the attachment object body to the attachment body. Accordingly, if the positional displacement described above occurs, then there is the possibility that deformation such as warping may occur with the speaker grill which is an attachment object body or the speaker grill may float from the speaker box which is an attachment body to make the attachment state of the speaker grill to the speaker box unstable.

It is desirable for a retention member to overcome the problem described above and achieve stabilization of the attachment state of the attachment object body to the attachment body.

According to the present technology, such a retention member as described above is implemented by providing a structure for absorbing positional displacement of an insertion projection with respect to a fitting hole when the insertion projection is inserted upon attachment of the attachment object body to the attachment body.

In particular, according to one mode of the present technology, there is provided a retention member formed from an elastically deformable material for being inserted into a fitting hole formed in an attachment body to which an attachment object body having an insertion projection is to be attached or in an attachment object body to be attached to an attachment body having an insertion projection, including an outer cylinder portion configured to be fitted into the fitting hole, an inner cylinder portion positioned in a spaced relationship from an inner circumferential face of the outer cylinder portion in the inside of the outer cylinder portion for receiving the insertion projection inserted therein, and a plurality of connecting portions connected at the opposite ends thereof to the inner circumferential face of the outer cylinder portion and an outer circumferential face of the inner cylinder portion and positioned in a spaced relationship from each other in a circumferential direction of the inner cylinder portion.

In the retention member, if positional displacement of the insertion projection with respect to the fitting hole occurs, then the connecting portions of the retention member are elastically deformed to displace the inner cylinder portion with respect to the outer cylinder portion to absorb the positional displacement. Therefore, stabilization of the attached state of the attachment object body to the attachment body can be anticipated.

Preferably, in the retention member, the connecting portions are provided at positions different from symmetric positions with respect to the center axis of the inner cylinder portion.

In the retention member, since the connecting portions are provided at positions different from symmetrical positions with respect to the center axis of the inner cylinder portion, if positional displacement of the insertion projection with respect to the fitting hole occurs, then the displacement of the inner cylinder portion with respect to the outer cylinder portion is hard to be restricted. Consequently, the positional displacement of the insertion projection with respect to the fitting hole is absorbed with certainty, and a stabilized attached state of the attachment object body to the attachment body can be assured.

Preferably, in the retention member, the connecting portions are positioned in an equally spaced relationship from each other, and the number of the connecting portions is a prime number of three or more.

In the retention member, since the connecting portions are positioned in an equally spaced relationship from each other and the number of the connecting portions is a prime number of three or more, the connecting portions exist at positions different from symmetrical positions with respect to the center axis of the inner cylinder portion. Therefore, if positional displacement of the insertion projection with respect to the fitting hole occurs, then the inner cylinder portion can be displaced readily with respect to the outer cylinder portion, and a further stabilized connection state of the inner cylinder portion to the outer cylinder portion can be assured.

Particularly preferably, the number of the connecting portions is three.

In the retention member, since the number of the connecting portions is three, a stabilized connection state of the inner cylinder portion to the outer cylinder portion by the connecting portions can be assured. Therefore, simplification of the structure of the retention member is achieved, and a stabilized connection state of the inner cylinder portion to the outer cylinder portion can be assured.

Preferably, in the retention member, the connecting portions have a linear sectional shape orthogonal to an axial direction of the inner cylinder portion, and the connecting portions extend in directions different from radial directions with respect to the center axis of the inner cylinder portion in the sectional shape.

In the retention member, the connecting portions have a linear sectional shape orthogonal to an axial direction of the inner cylinder portion, and the connecting portions extend in directions different from radial directions with respect to the center axis of the inner cylinder portion in the sectional shape. Therefore, since the connecting portions are deformed readily, displacement of the inner cylinder portion with respect to the outer cylinder portion is hard to be restricted, and when positional displacement of the insertion projection with respect to the fitting hole occurs, the inner cylinder portion can be displaced readily with respect to the outer cylinder portion.

Preferably, in the retention member, the connecting portions have a curved sectional shape orthogonal to an axial direction of the inner cylinder portion.

In the retention member, since the connecting portions have a curved sectional shape orthogonal to an axial direction of the inner cylinder portion, the connecting portions are deformed readily. Therefore, displacement of the inner cylinder portion with respect to the outer cylinder portion is hard to be restricted, and when positional displacement of the insertion projection with respect to the fitting hole occurs, the inner cylinder portion can be displaced readily with respect to the outer cylinder portion.

Preferably, in the retention member, the outer cylinder portion has an outer circumferential face on which a retaining projection is provided in such a manner as to be swollen outwardly and configured to be contacted in an elastically deformed state with the circumferential face which forms the fitting hole.

In the retention member, since the outer cylinder portion has an outer circumferential face on which a retaining projection is provided in such a manner as to be swollen outwardly and configured to be contacted in an elastically deformed state with the circumferential face which forms the fitting hole, the retaining projection is closely contacted with the circumferential face which forms the fitting hole. Accordingly, dropout of the retaining member from the fitting hole can be prevented by frictional force and elastic force of the retaining projection.

Preferably, in the retention member, the outer cylinder portion has a flange portion provided at one end portion thereof in the axial direction in such a manner as to be swollen outwardly and configured to be pressed against an outer side opening edge of the fitting hole.

In the retention member, since the outer cylinder portion has a flange portion provided at one end portion thereof in the axial direction in such a manner as to be swollen outwardly and configured to be pressed against an outer side opening edge of the fitting hole, the retention member is positioned at a predetermined position in the axial direction of the fitting hole. Therefore, insertion of the retaining member by more than a necessary amount into the fitting hole can be prevented, and good positioning accuracy of the retention member with respect to the attachment body or the attachment object body can be assured.

The above and other objects, features and advantages of the present invention will become apparent from the following description and the appended claims, taken in conjunction with the accompanying drawings in which like parts or elements denoted by like reference symbols.

### BRIEF DESCRIPTION OF THE DRAWINGS

FIG. 1 shows a retention member according to an embodiment of the present technology together with FIGS. 2 to 15 and is a perspective view of a rack in which the retention member is used;

FIG. 2 is an exploded perspective view showing part of the rack;

FIG. 3 is a perspective view of a side panel;

FIG. 4 is an enlarged perspective view of the retention member;

FIG. 5 is an enlarged perspective sectional view showing one half of the retention member;

FIG. 6 is an enlarged top plan view of the retention member;

FIG. 7 is an enlarged view showing the retention member as viewed from an axial direction;

FIG. 8 shows an assembly procedure of a base body, a side plate and a side panel together with FIGS. 9 and 10 and is a sectional view showing the retention member in a state in which the side plate is assembled to the base body;

FIG. 9 is a sectional view showing the retention member in a state in which it is inserted in fitting holes of the base body and fitting holes of the side plate;

FIG. 10 is a sectional view showing the retention member in a state in which insertion projections of the side panel are inserted in an inner cylinder portion of the retention member and the side panel is attached to the base body and the side plate;

FIG. 11 is a sectional view showing the retention member in a state in which the side panel is attached to the base body and the side plate and a region in which attachment projections and the retention member are connected to each other is closed;

FIG. 12 is a side elevational view partly in section showing the retention member in a state in which, when positional displacement occurs, connection portions of the retention member are elastically deformed and then the inner cylinder portion is displaced with respect to an outer cylinder portion;

FIG. 13 is an enlarged view showing a retention member according to a first modification as viewed from an axial direction;

FIG. 14 is an enlarged view showing a retention member according to a section modification as viewed from an axial direction; and

FIG. 15 is an enlarged view showing a retention member according to a third modification as viewed from an axial direction.

### DETAILED DESCRIPTION OF THE PREFERRED EMBODIMENT

In the following, a retention member according to an embodiment of the present technology is described with reference to the drawings.

In the embodiment described below, the retention member according to the present technology is applied as a retention member for use with a rack in or on which a television receiver is accommodated or place.

It is to be noted that an application range of the retention member according to the present technology is not limited to a retention member for use with a rack in or on which a television receiver is accommodated or placed. The retention member according to the present technology can be widely applied to retention members to be used for a structure in which a plurality of insertion projections and a plurality of fitting holes are fitted with each other to attach an attachment object body to an attachment body. The retention member according to the present technology can be widely applied to retention members to be used for an electronic apparatus rack for accommodating or receiving various kinds of electronic apparatus such as, for example, a television receiver, a recording and reproduction apparatus such as a disk recorder, an image pickup apparatus such as a video camera or a still camera, and an information processing apparatus such as a personal computer therein or thereon. Further, the retention member according to the present technology can be widely applied also to retention members to be used for various kinds of electronic apparatus such as a speaker apparatus.

### Configuration of the Rack

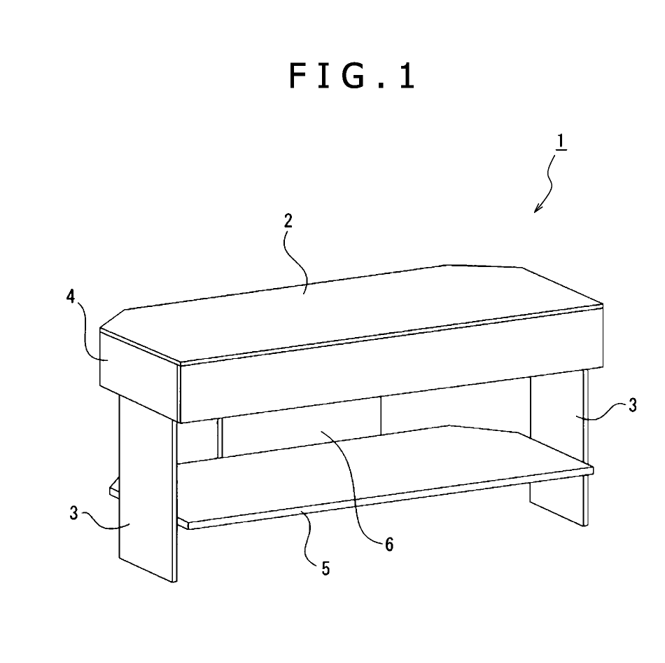

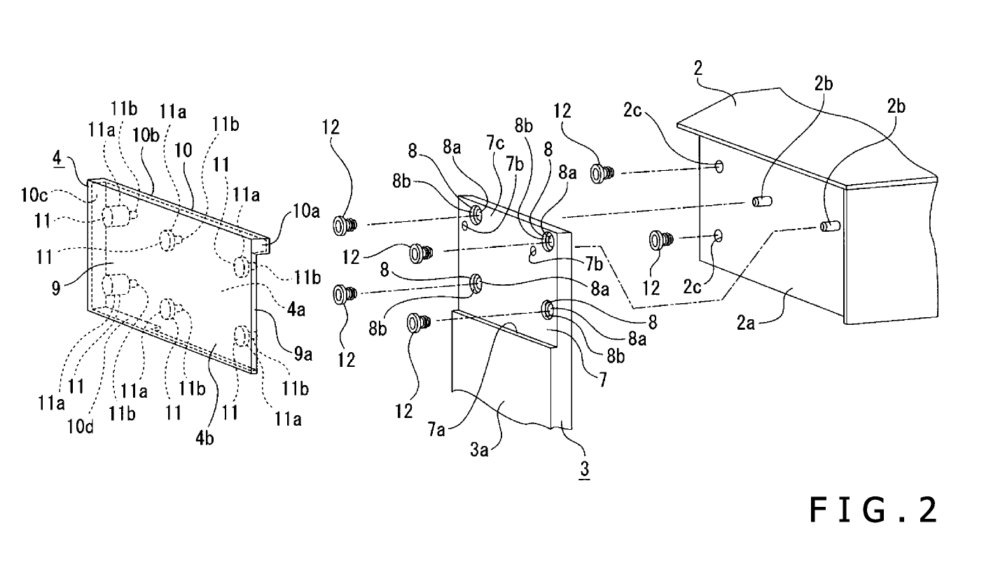

Referring to FIGS. 1 and 2, a rack 1 includes a base body (attachment body) 2 for accommodating or receiving an electronic apparatus such as a television receiver or a recording and reproduction apparatus therein or thereon. The rack 1 further includes a pair of side plates (attachment bodies) 3 assembled to the opposite side faces of the base body 2, and a pair of side panels (attachment object bodies) 4 attached to the base body 2 and the side plates 3 (only the left side panel is shown in FIG. 1). A shelf plate 5 is provided on the lower side of the base body 2 between the side plates 3, and the shelf board 5 and the base body 2 are connected to each other by a rear panel 6.

The base body 2 has, for example, a speaker, an amplifier and so forth not shown built therein. For example, two assembly projections 2b are provided in a spaced relationship from each other in the forward and backward direction on the opposite side faces 2a of the base body 2 (only those on the left side face are shown in FIG. 2). Further, for example, two fitting holes 2c are provided in a spaced relationship from each other in the upward and downward direction on the rear side of the assembly projections 2b on the opposite side faces 2a of the base body 2 (only those on the left side face are shown in FIG. 2).

Each of the side plates 3 is directed in the leftward and rightward directions and formed in a rectangular shape extending upwardly and downwardly. The side plate 3 has a length in the forward and backward direction smaller than the length of the side face 2a of the base body 2 in the forward and backward direction. An upper end portion 7 of the side plate 3 has a thickness smaller than that of the other portion of the side plate 3 and has, at a lower end thereof, a step face 7a which is directed upwardly. A pair of assembly holes 7b are formed in a spaced relationship from each other in the forward and backward direction in the upper end portion 7 of the side plate 3, and the assembly projections 2b of the base body 2 are individually inserted in the assembly holes 7b.

For example, four fitting holes 8 are formed in a spaced relationship from each other in the upward and downward direction and the forward and backward direction in the upper end portion 7 of the side plate 3. The fitting holes 8 are positioned, for example, at the four corner portions of the upper end portion 7. Each of the fitting holes 8 extends in the leftward and rightward direction through the upper end portion 7 and has a small diameter portion 8a and a large diameter portion 8b connected to each other. The small diameter portion 8a and the large diameter portion 8b of the fitting hole 8 have center axes aligned with each other, and an end portion of the base body 2 on the opposite side to the side face 2a is formed as the large diameter portion 8b. Accordingly, the small diameter portion 8a has a length in the axial direction greater than that of the large diameter portion 8b.

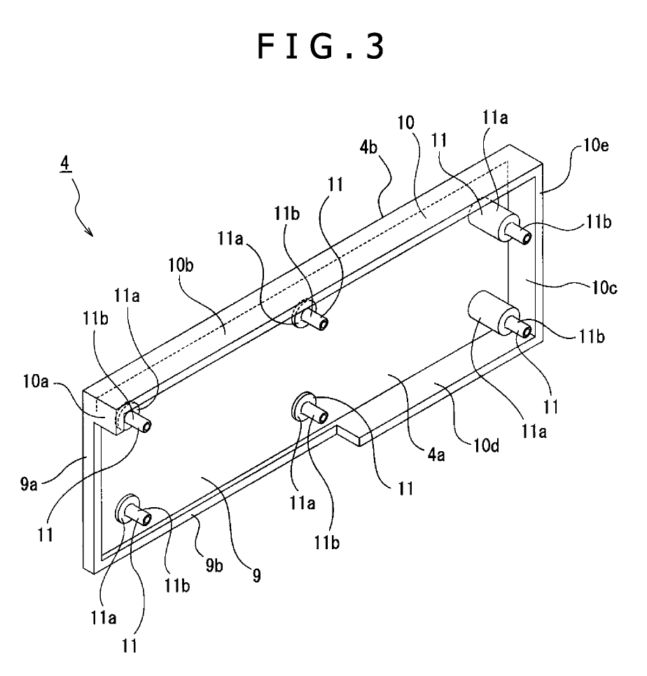

Each of the side panels 4 is directed in the leftward and rightward direction and formed in a rectangular shape. The length of the side panel 4 in the forward and backward direction is substantially equal to the length of the side face 2a of the base body 2 in the forward and backward direction. The side panel 4 has a panel portion 9 substantially in the form of a flat plate, and a projection 10 projecting to the base body 2 side from part of an outer periphery of the panel portion 9 as seen in FIGS. 2 and 3.

A face of the side panel 4 directed to the base body 2 side, that is, an inner face of the side panel 4, is formed as an attachment object face 4a. A plurality of attachment projections 11 are provided in a spaced relationship from each other in the forward and backward direction and the upward and downward direction on the side panel 4 such that they project from the attachment object face 4a toward the base body 2 side. The number of such attachment projections 11 is equal to the sum of the numbers of the fitting holes 2c formed in the side face 2a of the base body 2 and the fitting holes 8 of the side plate 3, and particularly, three attachment projections 11 are provided at each of upper and lower positions.

Each of the attachment projections 11 is configured from a holding down portion 11a connecting to the attachment object face 4a, and an insertion projection 11b projecting from the holding down portion 11a toward the base body 2 side. The holding down portion 11a and the insertion projection 11b have axial centers registered with each other, and the diameter of the holding down portion 11a is greater than the diameter of the insertion projection 11b.

The holding down portions 11a of the attachment projections 11 positioned on the rear side have a greater length in the axial direction than the holding down portions 11a of the other attachment projections 11. The insertion projections 11b have an equal length in the axial direction.

The thickness of a portion of the side panel 4 at which the projection 10 is provided is equal to the thickness of a portion of the side plate 3 other than the upper end portion 7. The projection 10 is configured from a front side projection 10a, an upper side projection 10b, a rear side projection 10c and a lower side projection 10d as seen in FIG. 3. The front side projection 10a projects from an upper end portion of a front end portion of the panel portion 9, and the upper side projection 10b projects from an upper end portion of the panel portion 9. The rear side projection 10c extends from a rear end portion of the panel portion 9, and the lower side projection 10d projects from a substantially rear half portion of a lower end portion of the panel portion 9. A rib portion 9a is provided at a portion of the outer periphery of the panel portion 9 at which the projection 10 is not provided such that it projects to the base body 2 side.

The side panel 4 is configured such that the length of a portion thereof except the front side projection 10a from within the length thereof in the upward and downward direction is equal to the length in the upward and downward direction of the upper end portion 7 of the side plate 3 and the length thereof except the lower side projection 10d from within the length thereof in the forward and backward direction is equal to the length in the forward and backward direction of the upper end portion 7 of the side plate 3. Further, the thickness of a portion of the side panel 4 on which the rib portion 9a of the panel section 9 is provided is substantially equal to the width in the leftward and rightward direction of the step face 7a of the side plate 3.

Retention members 12 are individually inserted into the fitting holes 2c of the base body 2 and the fitting holes 8 of the side plate 3 as seen in FIG. 2.

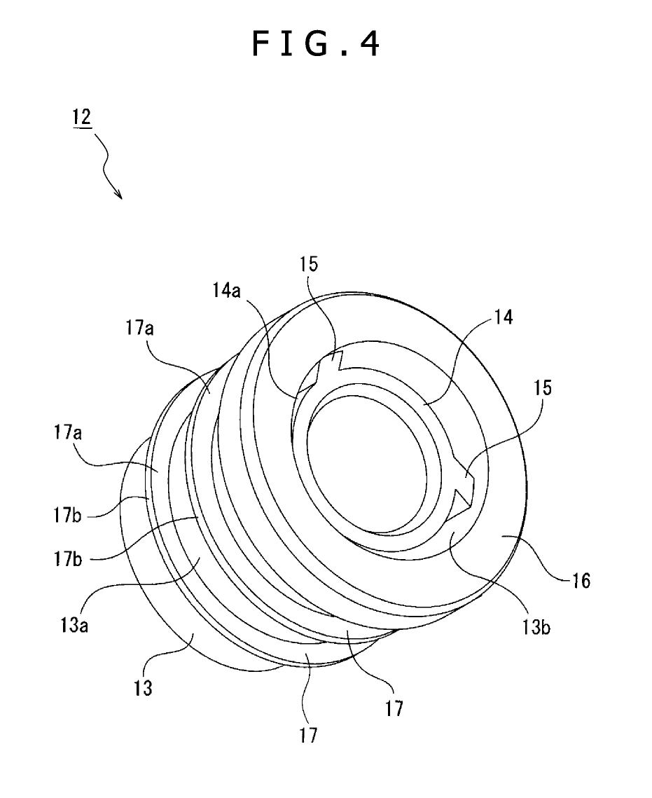

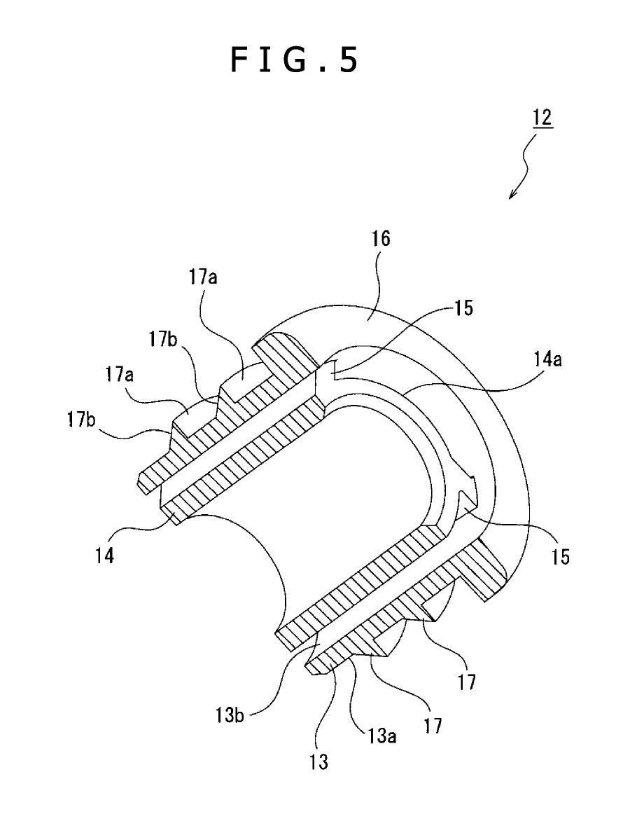

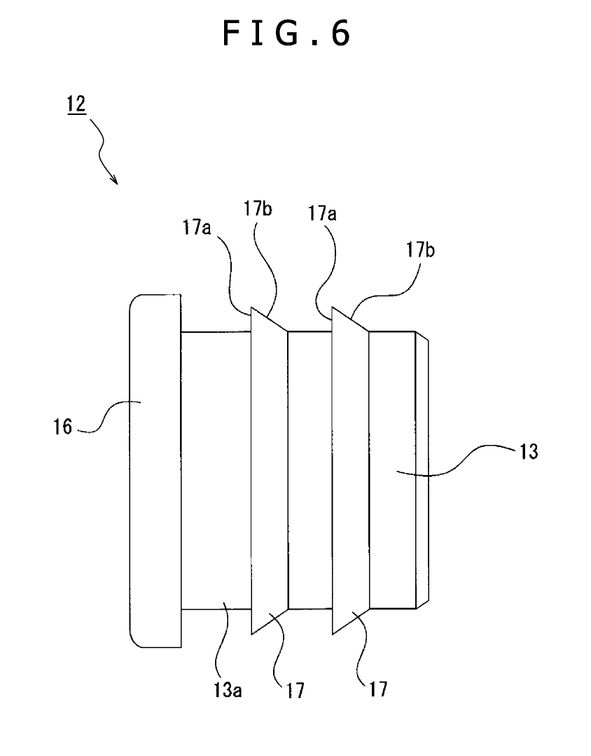

The retention members 12 are formed from an elastically deformable material such as rubber or elastomer. Referring to FIGS. 4 to 7, each of the retention members 12 includes an outer cylinder portion 13 for engaging with a fitting hole 2c of the base body 2 or a fitting hole 8 of the side plate 3, an inner cylinder portion 14 positioned on the inner side of the outer cylinder portion 13, and, for example, three connecting portions 15 positioned between and connected to the outer cylinder portion 13 and the inner cylinder portion 14. The outer cylinder portion 13, inner cylinder portion 14 and connecting portions 15 are formed integrally with each other.

The outer cylinder portion 13 is formed in a substantially cylindrical shape and has an end portion in the axial direction provided as an outwardly swollen flange portion 16. The flange portion 16 has an outer diameter greater than the diameter of the fitting hole 2c of the base body 2 and smaller than the diameter of the large diameter portion 8b of the side plate 3 but greater than the diameter of the smaller diameter portion 8a of the side plate 3. At an intermediate portion of the outer cylinder portion 13 in the axial direction, a pair of retaining projections 17 are provided in a spaced relationship from each other in the axial direction such that they are swollen outwardly from an outer circumferential face 13a. Each of the retaining projections 17 has an outer face configured from a flat face 17a directed to the flange portion 16 side and an inclined face 17b inclined so as to be displaced to the inner side as the distance from the flange portion 16 increases.

The inner cylinder portion 14 is formed in a cylindrical shape and has an outer diameter smaller than the inner diameter of the outer cylinder portion 13. The inner cylinder portion 14 has an outer circumferential face 14a positioned in a spaced relationship from an inner circumferential face 13b of the outer cylinder portion 13. The inner cylinder portion 14 has an inner diameter substantially equal to the outer diameter of the insertion projections 11b of the side panel 4, and an insertion projection 11b is inserted into the inner cylinder portion 14. The length of the inner cylinder portion 14 in the axial direction is a little smaller than the length of the outer cylinder portion 13 in the axial direction, and the inner cylinder portion 14 is positioned on the inner side of the outer cylinder portion 13 except an end portion of the outer cylinder portion 13 in the axial direction.

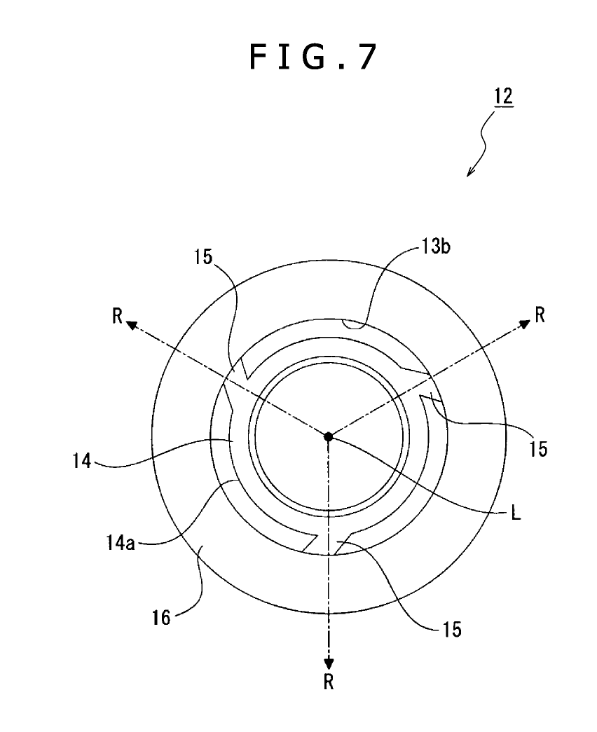

Referring to FIG. 7, the connecting portions 15 are positioned in an equally spaced relationship from each other in the circumferential direction of the inner cylinder portion 14 and are provided at positions different from symmetrical positions with respect to the center axis L of the inner cylinder portion 14. Each of the connecting portions 15 is connected at an outer end thereof to the inner circumferential face 13b of the outer cylinder portion 13 and at an inner end thereof to the outer circumferential face 14a of the inner cylinder portion 14. The connecting portion 15 extends, for example, in the axial direction of the outer cylinder portion 13 and the inner cylinder portion 14 such that the length thereof in the extending direction is equal to the length of the inner cylinder portion 14 in the axial direction. It is to be noted that a plurality of such connection portions may be provided in a spaced relationship from each other in the axial direction of the inner cylinder portion 14. The sectional shape of the connecting portion 15 perpendicular to the axial direction of the inner cylinder portion 14 is formed, for example, in a linear shape having a predetermined thickness.

The connecting portion 15 is provided such that it extends, in the sectional shape thereof perpendicular to the axial direction of the inner cylinder portion 14, in a direction different from a radial direction R with respect to the center axis L of the inner cylinder portion 14.

### Assembling Operation of the Rack

In the following, an assembling operation of the base body 2, side plates 3 and side panels 4 of the rack 1 described above is described with reference to FIGS. 2 and 8 to 12.

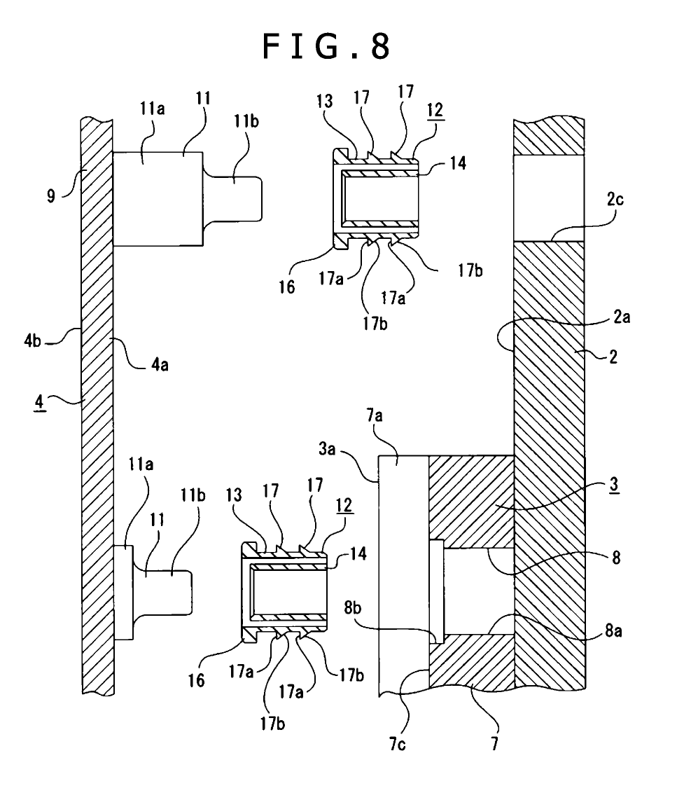

First, a side plate 3 is assembled to the base body 2 as seen in FIG. 8. The assembly of the side plate 3 to the base body 2 is carried out by force fitting the assembly projections 2b into the attachment holes 7b as seen from FIG. 2. The side plate 3 is assembled to the base body 2 in a state in which it is displaced to the front end side of the base body 2.

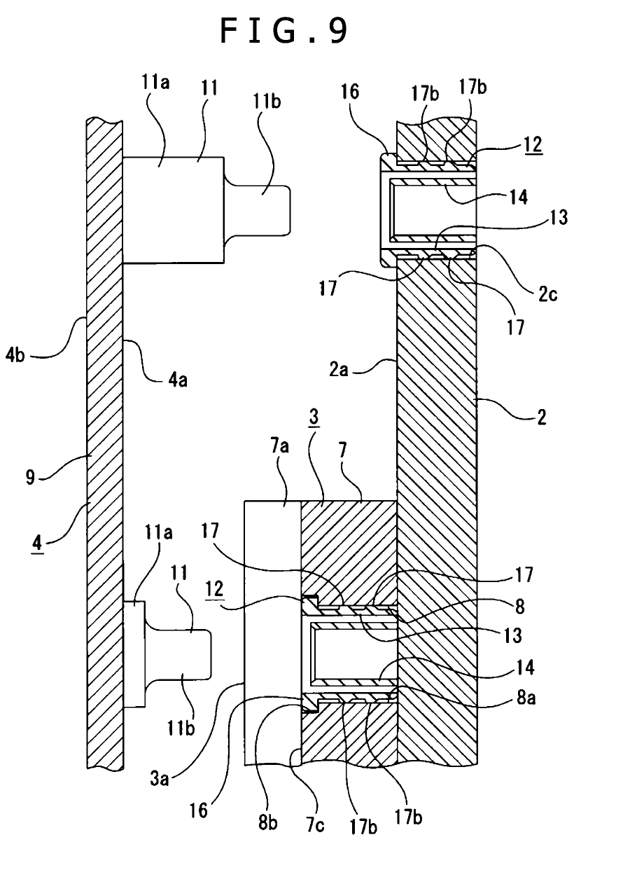

Then, the retention members 12 are inserted and fitted into the fitting holes 2c of the base body 2 and the fitting holes 8 of the side plate 3 in a state in which the flange portion 16 of the outer cylinder portion 13 thereof is positioned on the side panel 4 side as seen in FIGS. 2 and 9.

Each retention member 12 is inserted at a portion other than the flange portion 16 thereof into a fitting hole 2c. In the state in which the retention member 12 is inserted in the fitting hole 2c, the retaining projections 17 are elastically deformed at an end portion on the outer periphery side thereof and closely contact at the inclined face 17b thereof with the circumferential face which forms the fitting hole 2c. Further, the flange portion 16 is placed in a state in which it is pressed against the outer side opening edge of the fitting hole 2c.

Meanwhile, the retention member 12 is inserted as a whole into a fitting hole 8 and is inserted at a portion other than the flange portion 16 thereof into the smaller diameter portion 8a while the flange portion 16 is inserted into the large diameter portion 8b. In the state in which the retention member 12 is inserted in the fitting hole 8, the retaining projections 17 are resiliently deformed at an end portion on the outer peripheral side thereof and closely contact at the inclined face 17b thereof with the circumferential face which forms the smaller diameter portion 8a. Further, the flange portion 16 is placed in a state in which it is pressed against the outer side opening edge of the smaller diameter portion 8a. At this time, the face of the flange portion 16 on the side panel 4 side and the outer face 7c of the upper end portion 7 of the side plate 3 are positioned in a substantially same plane.

As described hereinabove, the retention member 12 has the flange portion 16 provided thereon and is pressed at the flange portion 16 thereof against the outer side opening edge of the fitting hole 2c or smaller diameter portion 8a of the fitting hole 8. Accordingly, insertion of the retention member 12 into the fitting hole 2c and the fitting hole 8 by more than a necessary amount can be prevented and good positioning accuracy of the retention member 12 with respect to the base body 2 or the side plate 3 can be assured.

Further, in the state in which the retention member 12 is fitted in the fitting hole 2c or the fitting hole 8, since the retaining projections 17 contact in an elastically deformed state with the circumferential face which forms the fitting hole 2c or the fitting hole 8, dropout of the retention member 12 from the fitting hole 2c or the fitting hole 8 can be prevented by the frictional force or elastic force of the retaining projections 17.

It is to be noted that, while the example in which the retention members 12 are inserted into the fitting holes 2c or 8 after the side plate 3 is assembled to the base body 2 is described above, conversely the side plate 3 may be assembled to the base body 2 after the retention members 12 are inserted into the fitting holes 2c or 8.

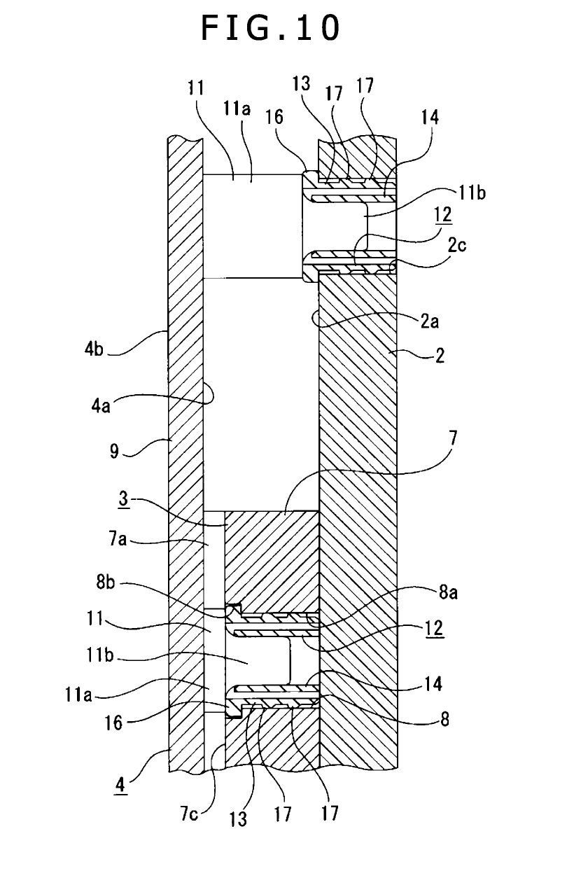

Thereafter, the insertion projections 11b of the side panel 4 are inserted in a force fitted state into the inner cylinder portions 14 of the retention members 12 fitted in the fitting holes 2c and the fitting holes 8 to attach the side panel 4 to the base body 2 and the side plate 3 as seen in FIG. 10.

When the insertion projections 11b are inserted into the inner cylinder portions 14, the holding down portions 11a are brought into contact with the flange portions 16 of the retention members 12 to establish a state in which the retention members 12 are pressed by the holding down portions 11a.

In the rack 1, the holding down portions 11a of those attachment projections 11 which are positioned on the rear side have a greater length in the axial direction than the holding down portions 11a of the other attachment projections 11. Accordingly, in the state in which the side panel 4 is attached to the base body 2 and the side plate 3 and the retention members 12 are pressed by the holding down portions 11a, the distance between the attachment object face 4a of the side panel 4 and the side face 2a of the base body 2 is fixed in the forward and backward direction.

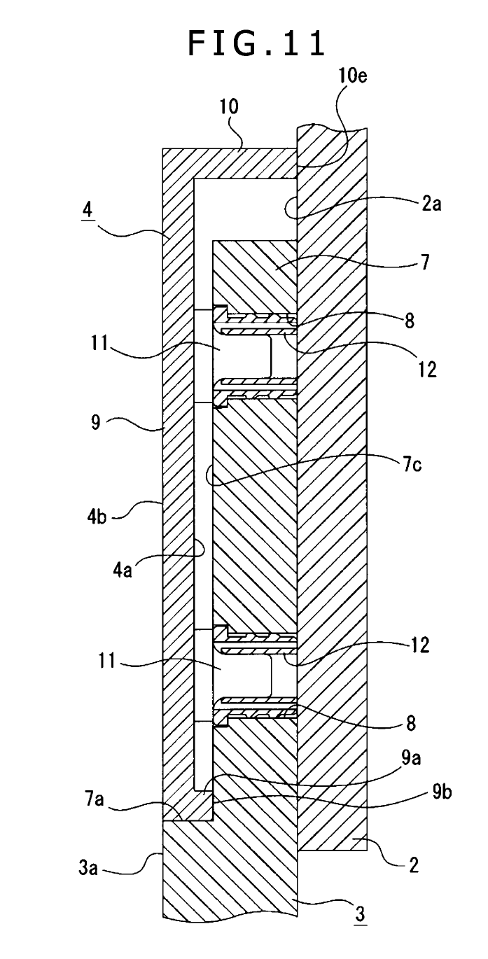

Further, in the rack 1, the portion of the side panel 4 at which the projection 10 is provided has a thickness equal to that of the portion of the side plate 3 other than the upper end portion 7. Furthermore, the side panel 4 has an equal length at the portion thereof other than the front side projection 10a from within the length thereof in the upward and downward direction to the length of the upper end portion 7 of the side plate 3 in the upward and downward direction. Further, the side panel 4 has an equal length at the portion thereof except the lower side projection 10d from within the length thereof in the forward and backward direction to the length of the upper end portion 7 of the side plate 3 in the forward and backward direction. Accordingly, as seen in FIG. 11, the side panel 4 is attached to the base body 2 and the side plate 3 in a state in which the side panel 4 contacts at the end faces 10e and 9b in the projecting direction of the projection 10 and the rib portion 9a thereof with the side face 2a of the base body 2 and the outer face 7c of the upper end portion 7 of the side plate 3, respectively, and no gap appears between the base body 2 and the side plate 3. Thus, the coupled portions of the attachment projections 11 and the retention members 12 are closed up with the side panel 4.

Furthermore, in the rack 1, the portion of the side panel 4 at which the rib portion 9a of the panel section 9 is provided has a thickness substantially equal to the width of the step face 7a of the side plate 3 in the leftward and rightward direction as described hereinabove. Thus, in the state in which the side panel 4 is attached to the base body 2 and the side plate 3, the outer face 4b of the side panel 4 and the outer face 3a of the side plate 3 are positioned on the same plane.

Since, in the state in which the side panel 4 is attached to the base body 2 and the side plate 3, the coupled portions of the attachment projections 11 and the retention members 12 are closed up as described above, otherwise possible invasion of dust into the retention members 12 and the fitting holes 2c and 8 can be prevented. Consequently, stabilization of the attached state of the side panel 4 to the base body 2 and the side plate 3 can be anticipated.

In the rack 1, the distances between the fitting holes 2c and the fitting holes 8 and the distances between the insertion projections 11b to be inserted into the fitting holes 2c and the fitting holes 8 sometimes differ depending upon the working accuracy. If the side panel 4 is attached to the base body 2 and the side plate 3 in the state in which the distances of them are different in this manner, then positional displacement of the insertion projections 11b with respect to the fitting holes 2c or the fitting holes 8 occurs.

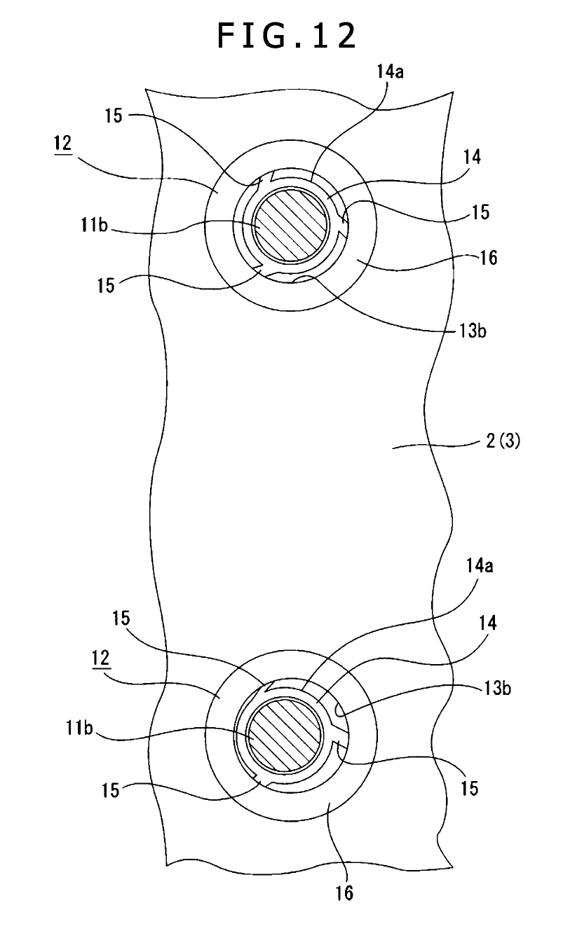

However, since the retention member 12 is formed from an elastically deformable material and is structured such that the outer cylinder portion 13 and the inner cylinder portion 14 is connected to each other by the connecting portions 15, if such positional displacement as described above occurs, then the retention member 12 is elastically deformed at least at the connecting portions 15 thereof to displace the inner cylinder portion 14 with respect to the outer cylinder portion 13 as seen in FIG. 12. Accordingly, the positional displacement of the insertion projection 11b with respect to the fitting hole 2c or 8 is absorbed by the retention member 12. Consequently, no unnecessary force is applied from the retention member 12 to the insertion projection 11b.

In the rack 1, the connecting portions 15 are provided at positions of the retention member 12 different from symmetrical positions with respect to the center axis of the inner cylinder portion 14 as described above. Accordingly, when such positional displacement as described above occurs, displacement of the inner cylinder portion 14 with respect to the outer cylinder portion 13 is hard to be restricted. Consequently, the positional displacement described above is absorbed with certainty, and a stabilized attached state of the side panel 4 to the base body 2 and the side plate 3 can be assured.

Further, as described hereinabove, since the three connecting portions 15 of the retention member 12 are disposed at equal distances in the circumferential direction of the inner cylinder portion 14, a stabilized connected state of the inner cylinder portion 14 to the outer cylinder portion 13 by the connecting portions 15 is assured. Accordingly, while simplification of the structure of the retention member 12 is achieved, a stabilized connection state of the inner cylinder portion 14 to the outer cylinder portion 13 can be assured.

Furthermore, as described hereinabove, the connecting portions 15 have a linear sectional shape perpendicular to the axial direction of the inner cylinder portion 14 and are provided such that they extend in directions different from radial directions R from the center axis L of the inner cylinder portion 14. Accordingly, since the connecting portions 15 are deformed readily, the displacement of the inner cylinder portion 14 with respect to the outer cylinder portion 13 is hard to be restricted. Thus, if positional displacement of the insertion projection 11b with respect to the fitting hole 2c or the fitting hole 8 occurs, then the inner cylinder portion 14 can be displaced readily with respect to the outer cylinder portion 13.

### Modifications to the Retention Member

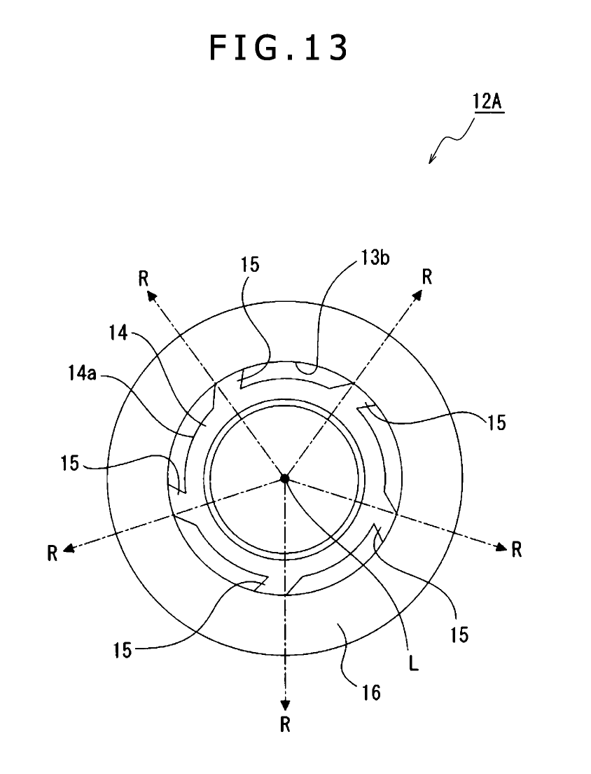

In the following, several modifications to the holding member are described with reference to FIGS. 13 to 15.

It is to be noted that, since the retention members according to the modifications described below are different from the retention member 12 only in number, shape and position of the connection portions, only such differences of the retention members from the retention member 12 are described in detail while overlapping description of like elements is omitted herein to avoid redundancy.

### <First Modification>

Referring first to FIG. 13, there is shown a retention member 12A according to a first modification. In the retention member 12A, an outer cylinder portion 13, an inner cylinder portion 14 and, for example, five connecting portions 15 are formed integrally.

The connecting portions 15 are positioned in an equally spaced relationship from each other in a circumferential direction of the inner cylinder portion 14 and have, in a direction perpendicular to the axial direction of the inner cylinder portion 14, a linear sectional shape extending in a direction different from the radial directions R from the center axis L of the inner cylinder portion 14.

It is to be noted that, while the retention member 12A described above has the five connecting portions 15 positioned in an equally spaced relationship from each other in the circumferential direction of the inner cylinder portion 14, the retention member 12A may otherwise have a prime number of connecting portions 15 greater than 5 which are positioned in an equally spaced relationship from each other in the circumferential direction of the inner cylinder portion 14. For example, the retention member 12A may be configured such that it has seven or eleven connecting portions 15.

Since the retention member 12A described above includes a prime number of connecting portions 15 greater than 3 which are positioned in an equally spaced relationship from each other in the circumferential direction of the inner cylinder portion 14, a further stabilized connection state of the inner cylinder portion 14 to the outer cylinder portion 13 by the connecting portions 15 is assured. Accordingly, if positional displacement of the insertion projection 11b with respect to the fitting hole 2c or the fitting hole 8 occurs, then the inner cylinder portion 14 can be displaced readily with respect to the outer cylinder portion 13. Consequently, a further stabilized connection state of the inner cylinder portion 14 to the outer cylinder portion 13 can be assured.

### <Second Modification>

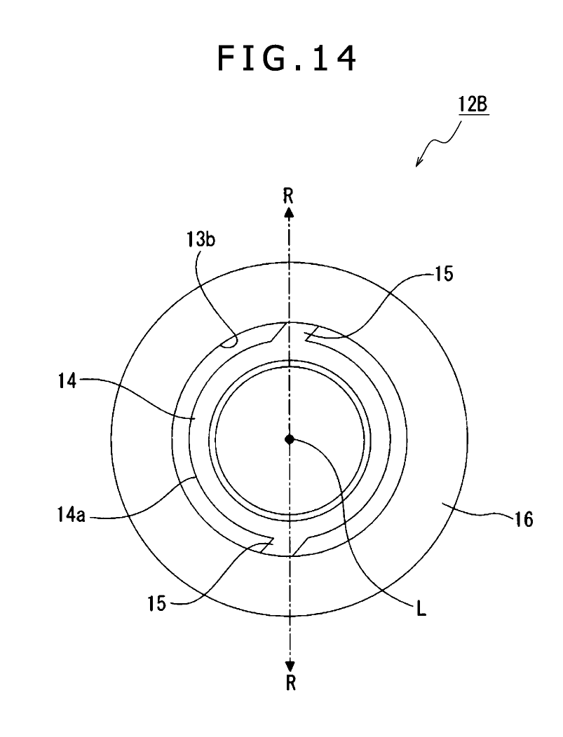

Referring now to FIG. 14, there is shown a retention member 12B according to a second modification. The retention member 12B includes an outer cylinder portion 13, an inner cylinder portion 14 and, for example, two connecting portions 15 formed integrally with each other.

The connecting portions 15 are provided at symmetrical positions with respect to the center axis L of the inner cylinder portion 14. The connecting portions 15 have a linear shape extending, in a sectional shape perpendicular to the axial direction of the inner cylinder portion 14, linearly in directions different from radial directions R from the center axis L of the inner cylinder portion 14.

It is to be noted that, while the retention member 12B described above has the two connecting portions 15 provided at symmetrical positions with respect to the center axis L of the inner cylinder portion 14, the two connecting portions 15 of the retention member 12B may be provided at positions different from symmetrical positions with respect to the center axis L of the inner cylinder portion 14.

As described above, in the retention member 12B, the outer cylinder portion 13 and the inner cylinder portion 14 are connected to each other by the two connecting portions 15. Accordingly, the number of connecting portions 15 is reduced, and consequently, reduction of the fabrication cost by simplification of the structure of the retention member 12B and reduction of the material to be used can be anticipated. Besides, stabilization of the attached state of the side panel 4 to the base body 2 and the side plate 3 can be anticipated.

### <Third Modification>

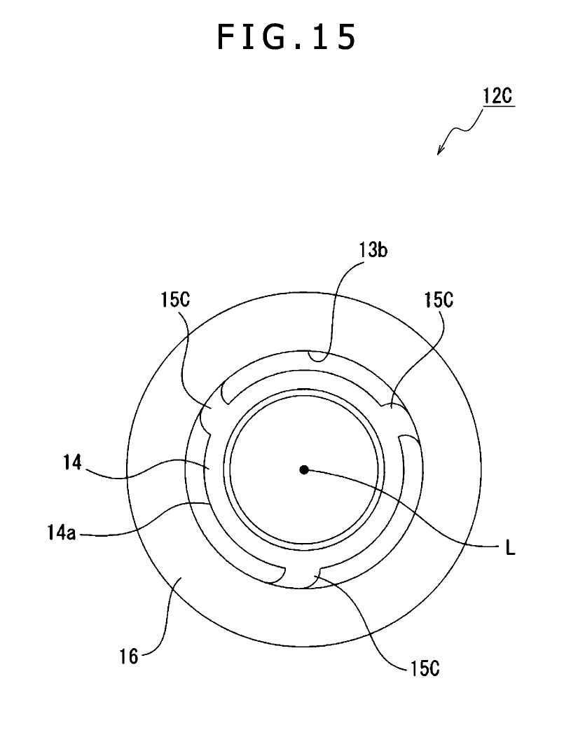

Referring now to FIG. 15, there is shown a retention member 12C according to a third modification. The retention member 12C includes an outer cylinder portion 13, an inner cylinder portion 14 and, for example, three connecting portions 15C formed integrally with each other.

The connecting portions 15C are positioned in an equally spaced relationship from each other in the circumferential direction of the inner cylinder portion 14 and are provided at positions different from symmetrical positions with respect to the center axis L of the inner cylinder portion 14. The connecting portions 15C have a sectional shape perpendicular to the axial direction of the inner cylinder portion 14, which is curved with a predetermined thickness.

It is to be noted that, while the retention member 12C described above has the three connecting portions 15C provided at equal distances in the circumferential direction of the inner cylinder portion 14, the connecting portions 15C of the retention member 12C may not be provided at equal distances in the circumferential direction of the inner cylinder portion 14 only if the sectional shape thereof in the direction perpendicular to the axial direction of the inner cylinder portion 14 is formed in a curve.

Further, while the retention member 12C described above has the three connecting portions 15C, the number of such connecting portions 15C provided on the retention member 12C may be an arbitrary number.

Furthermore, while the retention member 12C described above has the connecting portions 15C provided at positions different from symmetrical positions with respect to the center axis L of the inner cylinder portion 14, the connecting portions 15C may otherwise be provided at symmetrical positions with respect to the center axis L of the inner cylinder portion 14.

Since the connecting portions 15C of the retention member 12C in the direction perpendicular to the axial direction of the inner cylinder portion 14 have a curved sectional shape as described above, they are deformed readily. Accordingly, displacement of the inner cylinder portion 14 with respect to the outer cylinder portion 13 is hard to be restricted, and when positional displacement of the insertion projection 11b with respect to the fitting hole 2c or the fitting hole 8 occurs, the inner cylinder portion 14 can be displaced readily with respect to the outer cylinder portion 13.

It is to be noted that, in the retention members 12, 12A and 12B described above, each connecting portion 15 is provided such that it extends, in a sectional shape thereof perpendicular to the axial direction of the inner cylinder portion 14, in a direction different from a radial direction R with respect to the center axis L of the inner cylinder portion 14. However, in the retention members 12, 12A and 12B, the connecting portion 15 may otherwise be provided such that it extends, in a sectional shape thereof perpendicular to the axial direction of the inner cylinder portion 14, in the radial direction R with respect to the center axis L of the inner cylinder portion 14.

### CONCLUSION

As described above, the retention members 12, 12A, 12B and 12C are formed from an elastically deformable material and structured such that the outer cylinder portion 13 and the inner cylinder portion 14 positioned in a spaced relationship from the inner circumferential face 13b of the outer cylinder portion 13 are connected to each other by the plural connecting portions 15 or the plural connecting portions 15C.

Accordingly, when positional displacement with respect to the fitting hole 2c of the insertion projection 11b or the fitting hole 8 occurs, the retention member 12, 12A, 12B or 12C is elastically deformed at least at the plural connecting portion 15 or the plural connecting portion 15C thereof to displace the inner cylinder portion 14 with respect to the outer cylinder portion 13. Therefore, stabilization of the attached state of the side panel 4 to the base body 2 and the side plate 3 can be anticipated.

It is to be noted that, in the examples described above, the plural insertion projections 11b provided on the side panel 4, which is an attachment object body, are inserted into the plural fitting holes 2c and 8 formed in the base body 2, which is an attachment body, and the side plate 3, which is an attachment body to attach the side panel 4 to the base body 2 and the side plate 3, respectively. However, such a converse structure may be adopted alternatively that a plurality of fitting holes are formed in an attachment object body while a plurality of insertion projections are provided on an attachment body such that the insertion projections are inserted into the fitting holes to attach the attachment object body to the attachment body.

### PRESENT TECHNOLOGY

It is to be noted that the present technology can be carried out in such configurations as described below.

(1) A retention member formed from an elastically deformable material for being inserted into a fitting hole formed in an attachment body to which an attachment object body having an insertion projection is to be attached or in an attachment object body to be attached to an attachment body having an insertion projection, including an outer cylinder portion configured to be fitted into the fitting hole, an inner cylinder portion positioned in a spaced relationship from an inner circumferential face of the outer cylinder portion in the inside of the outer cylinder portion for receiving the insertion projection inserted therein, and a plurality of connecting portions connected at the opposite ends thereof to the inner circumferential face of the outer cylinder portion and an outer circumferential face of the inner cylinder portion and positioned in a spaced relationship from each other in a circumferential direction of the inner cylinder portion.

(2) The retention member according to the item (1), wherein the connecting portions are provided at positions different from symmetric positions with respect to the center axis of the inner cylinder portion.

(3) The retention member according to the item (1), wherein the connecting portions are positioned in an equally spaced relationship from each other, and the number of the connecting portions is a prime number of three or more.

(4) The retention member according the item (3), wherein the number of the connecting portions is three.

(5) The retention member according to any one of the items (1) to (4), wherein the connecting portions have a linear sectional shape orthogonal to an axial direction of the inner cylinder portion, and the connecting portions extend in directions different from radial directions with respect to the center axis of the inner cylinder portion in the sectional shape.

(6) The retention member according to any one of the items (1) to (4), wherein the connecting portions have a curved sectional shape orthogonal to an axial direction of the inner cylinder portion.

(7) The retention member according to any one of the items (1) to (6), wherein the outer cylinder portion has an outer circumferential face on which a retaining projection is provided in such a manner as to be swollen outwardly and configured to be contacted in an elastically deformed state with the circumferential face which forms the fitting hole.

(8) The retention member according to any one of the items (1) to (7), wherein the outer cylinder portion has a flange portion provided at one end portion thereof in the axial direction in such a manner as to be swollen outwardly and configured to be pressed against an outer side opening edge of the fitting hole.

While a preferred embodiment of the present technology has been described using specific terms, such description is for illustrative purposes only, and it is to be understood that changes and variations may be made without departing from the spirit or scope of the following claims.

The present technology contains subject matter related to that disclosed in Japanese Priority Patent Application JP 2011-132132 filed in the Japan Patent Office on Jun. 14, 2011, the entire content of which is hereby incorporated by reference.

What is claimed is:

1. A retention member formed from an elastically deformable material for being inserted into a fitting hole formed in an attachment body to which an attachment object body having an insertion projection is to be attached or in an attachment object body to be attached to an attachment body having an insertion projection, comprising:
an outer cylinder portion configured to be fitted into the fitting hole;
an inner cylinder portion positioned in a spaced relationship from an inner circumferential face of said outer cylinder portion in the inside of said outer cylinder portion for receiving the insertion projection inserted therein; and
a plurality of connecting portions connected at the opposite ends thereof to the inner circumferential face of said outer cylinder portion and an outer circumferential face of said inner cylinder portion and positioned in a spaced relationship from each other in a circumferential direction of said inner cylinder portion.

2. The retention member according to claim 1, wherein said connecting portions are provided at positions different from symmetric positions with respect to the center axis of said inner cylinder portion.

3. The retention member according to claim 1, wherein said connecting portions are positioned in an equally spaced relationship from each other; and
the number of said connecting portions is a prime number of three or more.

4. The retention member according to claim 3, wherein the number of said connecting portions is three.

5. The retention member according to claim 1, wherein said connecting portions have a linear sectional shape orthogonal to an axial direction of said inner cylinder portion; and
said connecting portions extend in directions different from radial directions with respect to the center axis of said inner cylinder portion in the sectional shape.

6. The retention member according to claim 1, wherein said connecting portions have a curved sectional shape orthogonal to an axial direction of said inner cylinder portion.

7. The retention member according to claim 1, wherein said outer cylinder portion has an outer circumferential face on which a retaining projection is provided in such a manner as to be swollen outwardly and configured to be contacted in an elastically deformed state with the circumferential face which forms the fitting hole.

8. The retention member according to claim 1, wherein said outer cylinder portion has a flange portion provided at one end portion thereof in the axial direction in such a manner as to be swollen outwardly and configured to be pressed against an outer side opening edge of the fitting hole.
